(19) United States
(12) Patent Application Publication
(10) Pub. No.: US 2013/0312625 A1
(43) Pub. Date: Nov. 28, 2013

(54) SECURITIES PRINTER

(71) Applicant: Hiroyoshi Kamoda, Tsukuba-shi (JP)

(72) Inventor: Hiroyoshi Kamoda, Tsukuba-shi (JP)

(73) Assignee: KOMORI CORPORATION, Tokyo (JP)

(21) Appl. No.: 13/993,735

(22) PCT Filed: Nov. 29, 2011
(86) PCT No.: PCT/JP2011/077462

§ 371 Date: Aug. 15, 2013

(30) Foreign Application Priority Data
Dec. 14, 2010 (JP) 2010-277832
Nov. 14, 2011 (JP) 2011-248391

(51) Int. Cl. B41F 9/00

(52) U.S. Cl. CPC B41F 9/002
USPC 101/153

(57) ABSTRACT

A printer is provided with: offset printing units (120 to 150) comprising impression cylinders (121a to 151a, 121b to 151b) for holding and transferring a sheet (101), blanket cylinders (122a to 152a, 122b to 152b) facing the impression cylinders (121a to 151a, 121b to 151b), plate cylinders (123a to 153a, 123b to 153b) facing the blanket cylinders (122a to 152a, 122b to 152b), and ink devices (124a to 154a, 124b to 154b) for supplying ink to the plate cylinders (123a to 153a, 123b to 153b); and an intaglio printing unit (180) comprising an impression cylinder (181) which receives the sheet (101) subjected to offset printing in the offset printing unit (150) and holds and transfers the sheet (101), an intaglio plate cylinder (182) facing the impression cylinder (181), ink supply means (183 to 185) for supplying ink to the intaglio plate cylinder (182), and the like.

### TECHNICAL FIELD

The present invention relates to a security printing press for printing banknotes such as bank bills and securities such as stock certificates and bond certificates.

### BACKGROUND ART

As described for example in Patent Literature 1 listed below and the like, a security printing press employed for printing banknotes such as bank bills and securities such as stock certificates and bond certificates is one which performs offset printing of printing images of a plurality of colors simultaneously on both surfaces of a sheet, by transferring printing images of inks of the respective colors onto two blanket cylinders, which are in contact with each other, from a plurality of inking devices disposed along circumferential directions of the blanket cylinders via corresponding plate cylinders, and by causing the sheet to pass between the blanket cylinders, and which then performs intaglio printing by means of an intaglio printing plate.

### CITATION LIST

### Patent Literatures

Patent Literature 1: Japanese Patent Application Publication No. Hei 2-187337
Patent Literature 2: Japanese Patent Application Publication No. Hei 11-105249
Patent Literature 3: Japanese Patent Application Publication No. 2001-225441
Patent Literature 4: Japanese Patent Application Publication No. 2000-127349
Patent Literature 5: Published Japanese Translation of International Application No. Hei 7-002417
Patent Literature 6: Japanese Patent Application Publication No. 2007-106128
Patent Literature 7: Japanese Patent No. 2722022
Patent Literature 8: Japanese Patent No. 4025255

### SUMMARY OF INVENTION

### Technical Problem

Such a security printing press as described above, however, performs offset printing on the sheet by pressing the sheet with the blanket cylinders each having an elastic rubber blanket wound around the surface thereof. For this reason, the security printing press is incapable of performing offset printing of sharp printing images on the sheet.

In view of the above-described circumstances, an object of the present invention is to provide a security printing press capable of performing offset printing of sharp printing images on a sheet, and continuously performing intaglio printing on the sheet in line.

### Solution to Problem

To solve the above-described problem, a security printing press for printing securities according to the present invention is characterized in that the security printing press comprises: an offset printing unit including an impression cylinder which holds and transports a sheet, a blanket cylinder which is in contact with the impression cylinder, a plate cylinder which is in contact with the blanket cylinder, and ink supply means for supplying ink to the plate cylinder; and an intaglio printing unit including an impression cylinder which receives the sheet subjected to offset printing in the offset printing unit and holds and transports the sheet, an intaglio cylinder which is in contact with the impression cylinder, an ink collecting cylinder which is in contact with the intaglio cylinder, a plurality of ink form cylinders which are in contact with the ink collecting cylinder, and a plurality of inking devices which are disposed to respectively correspond to the ink form cylinders and which supply ink to the corresponding ink form cylinders.

In addition, the security printing press for printing securities according to the present invention is characterized in that in the above-described security printing press, the offset printing unit includes: an offset printing section for one surface including an impression cylinder for one surface which holds and transports the sheet, a blanket cylinder for one surface which is in contact with the impression cylinder for one surface and which performs offset printing on one surface of the sheet, a plate cylinder for one surface which is in contact with the blanket cylinder for one surface, and ink supply means for one surface for supplying ink to the plate cylinder for one surface; and an offset printing section for the other surface including an impression cylinder for the other surface which is in contact with the impression cylinder for one surface of the offset printing section for one surface and which receives the sheet from the impression cylinder for one surface and holds and transports the sheet, a blanket cylinder for the other surface which is in contact with the impression cylinder for the other surface and which performs offset printing on the other surface of the sheet, a plate cylinder for the other surface which is in contact with the blanket cylinder for the other surface, and ink supply means for the other surface for supplying ink to the plate cylinder for the other surface, and each of the ink supply means for one surface of the offset printing section for one surface and the ink supply means for the other surface of the offset printing section for the other surface includes: two ink fountains; an oscillating roller; and oscillation adjusting means for adjusting oscillation of the oscillating roller.

In addition, the security printing press for printing securities according to the present invention is characterized in that the above-described security printing press further comprises at least one sheet forwarding cylinder which is disposed between the offset printing unit and the impression cylinder of the intaglio printing unit and which forwards the sheet subjected to offset printing in the offset printing unit to the impression cylinder of the intaglio printing unit.

In addition, the security printing press for printing securities according to the present invention is characterized in that in the above-described security printing press, the offset printing unit is configured as one module formed of the offset printing section for one surface and the offset printing section for the other surface, and a plurality of the offset printing units are capable of being coupled.

In addition, the security printing press for printing securities according to the present invention is characterized in that the above-described security printing press further comprises: checking means for one surface for detecting a printing condition of the one surface of the sheet, the checking means for one surface being disposed between a downstream side, in a transporting direction of the sheet, of a printing portion in the offset printing section for one surface that is located on the most downstream side in the transporting direction of the sheet and an upstream side, in the transporting direction of the sheet, of the impression cylinder of the intaglio printing unit, and checking means for the other surface for detecting a printing condition of the other surface of the sheet, the checking means for the other surface being disposed between a downstream side, in the transporting direction of the sheet, of a printing portion in the offset printing section for the other surface that is located on the most downstream side in the transporting direction of the sheet and an upstream side, in the transporting direction of the sheet, of the impression cylinder of the intaglio printing unit.

In addition, the security printing press for printing securities according to the present invention is characterized in that the above-described security printing press further comprises: plate changing means for one surface for changing a printing plate for the plate cylinder for one surface, the plate changing means for one surface being provided in the offset printing section for one surface; and plate changing means for the other surface for changing a printing plate for the plate cylinder for the other surface, the plate changing means for the other surface being provided in the offset printing section for the other surface.

### Advantageous Effects of Invention

According to the security printing press of the present invention, printing is performed one surface of a sheet held on the impression cylinder for one surface by the blanket cylinder for one surface, the sheet is then gripped and held on the impression cylinder for the other surface, and printing is performed on the other surface of the sheet by the blanket cylinder for the other surface. In short, the security printing press employs alternate double-side printing. Therefore, when printing is performed on each of both surfaces of the sheet, the sheet is pressed against the blanket cylinder by the impression cylinder, making it possible to print sharp printing images on both surfaces of the sheet.

### BRIEF DESCRIPTION OF DRAWINGS

FIG. 1 is an overall schematic configuration diagram of a main embodiment of a security printing press according to the present invention.

FIG. 2 is an enlarged diagram of an extracted part of an offset printing unit of the security printing press in FIG. 1.

FIG. 3 is an enlarged diagram of an extracted part of an intaglio printing unit of the security printing press in FIG. 1.

FIG. 4 is a schematic configuration diagram of a plate clamping device and a printing plate mounting device of an offset printing section for one surface of the security printing press in FIG. 1.

FIG. 5 is a schematic configuration diagram of a plate clamping device and a printing plate mounting device of an offset printing section for the other surface of the security printing press in FIG. 1.

FIG. 6 is a schematic configuration diagram of an oscillation adjusting device for an oscillating roller of the offset printing unit of the security printing press in FIG. 1.

FIG. 7 is a control block diagram of the oscillation adjusting device and a sheet sorting device of the offset printing unit of the security printing press in FIG. 1.

FIG. 8 is an overall schematic configuration diagram of another embodiment of the security printing press according to the present invention.

FIG. 9 is an overall schematic configuration diagram of still another embodiment of the security printing press according to the present invention.

FIG. 10 is an overall schematic configuration diagram of yet another embodiment of the security printing press according to the present invention.

### DESCRIPTION OF EMBODIMENTS

Although embodiments of a security printing press according to the present invention will be described on the basis of the drawings, the present invention is not limited to only the embodiments which are described below on the basis of the drawings.

### Main Embodiment

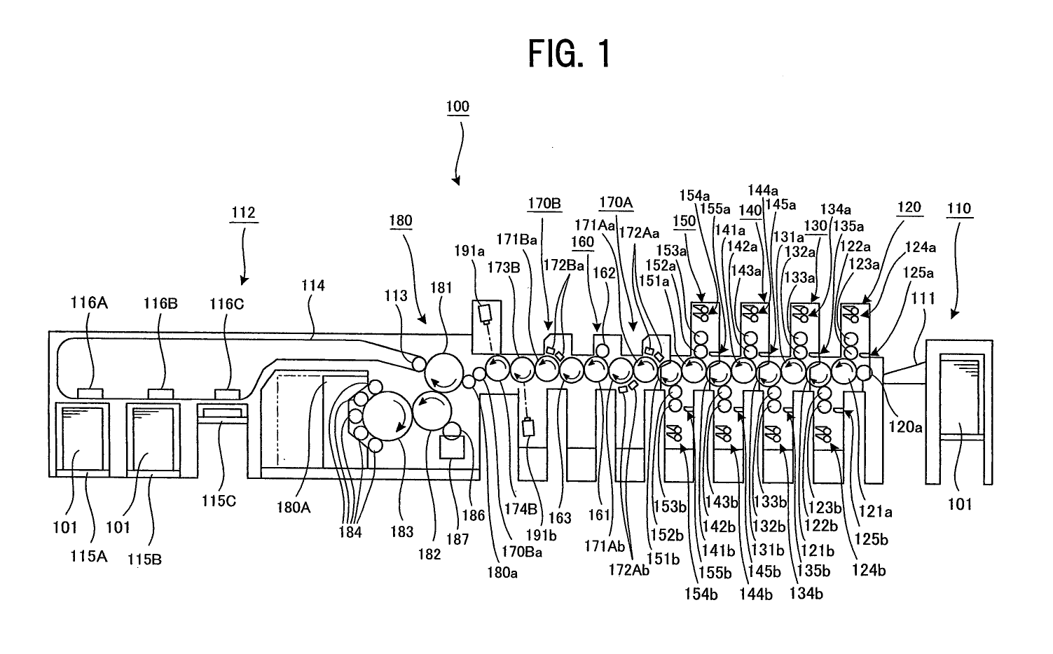

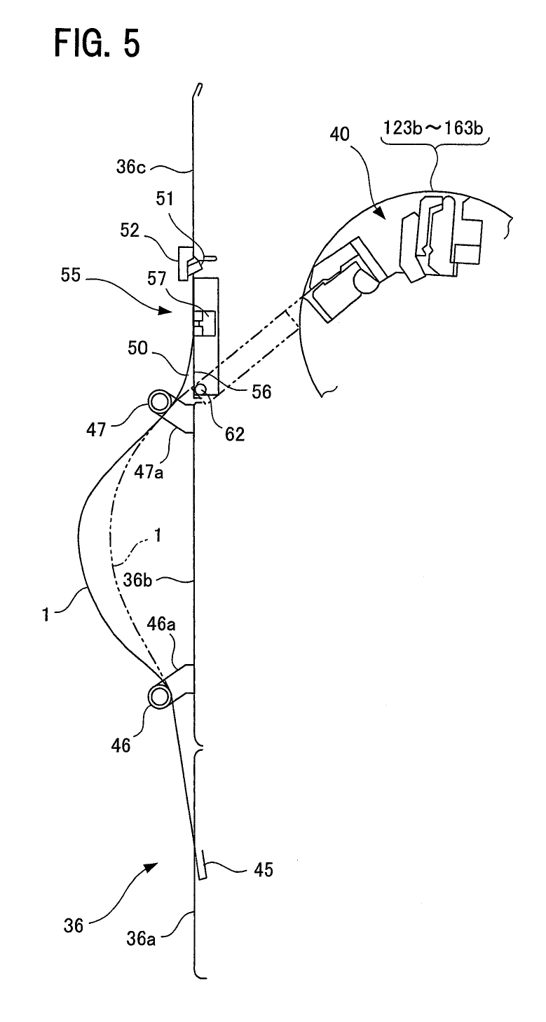

A main embodiment of the security printing press according to the present invention will be described on the basis of FIGS. 1 to 7.

### <<Overall Main Configuration>>

As shown in FIG. 1, a transfer cylinder 120a of a first offset printing unit 120 is disposed on a leading end side of a feeder board 111 of a sheet feeding device 110, which is sheet feeding means for feeding sheets 101 one by one. The transfer cylinder 120a is capable of receiving the sheets 101 one by one from the feeder board 111 via an unillustrated swing arm shaft pregripper.

An impression cylinder 121a for one surface of the first offset printing unit 120 is in contact with the transfer cylinder 120a of the first offset printing unit 120. A blanket cylinder 122a for one surface is in contact with the impression cylinder 121a. A plate cylinder 123a for one surface is in contact with the blanket cylinder 122a. An inking device 124a for one surface, which is ink supply means for one surface, and a dampening device 125a for one surface, which is a dampening means for one surface, are provided to the plate cylinder 123a. The impression cylinder 121a, the blanket cylinder 122a, the plate cylinder 123a, the inking device 124a, the dampening device 125a, as described above, and the like constitute an offset printing section for one surface of the first printing unit 120.

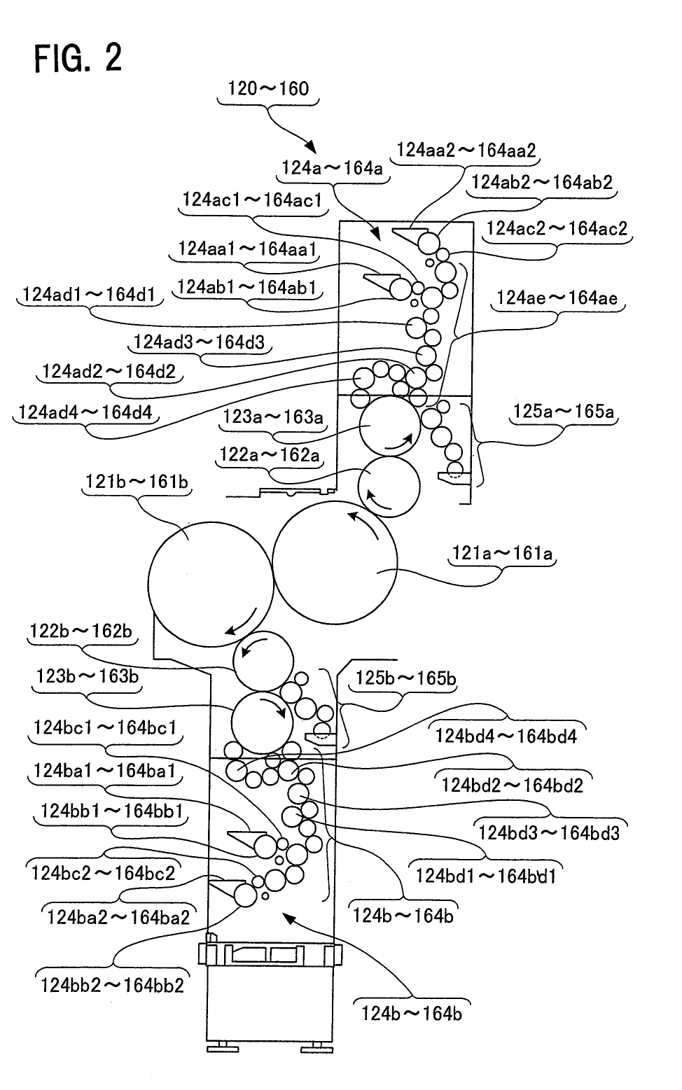

As shown in FIG. 2, the inking device 124a includes: two ink fountains 124aa1 and 124aa2 which are capable of containing inks of colors different from each other; fountain rollers 124ab1 and 124ab2 which take out the ink from the respective ink fountains 124aa1 and 124aa2; ink ductor rollers 124ac1 and 124ac2 which each have a large-diameter portion and a small-diameter portion at predetermined positions in an axial direction thereof and which receive the ink taken out by the respective fountain rollers 124ab1 and 124ab2 on only the large-diameter portions; a roller train 124ae to which the ink is transferred from the large-diameter portions of the ink ductor rollers 124ac1 and 124ac2 and which then sends the ink to the plate cylinder 123a; and oscillating rollers 124ad1 to 124ad4 which are disposed between the rollers of the roller train 124ae and which are capable of reciprocally moving in the axial direction.

As shown in FIG. 1, an impression cylinder 121b for the other surface of the first offset printing unit 120 is in contact with the impression cylinder 121a at a position downstream of the position where the blanket cylinder 122a is in contact with the impression cylinder 121a in a rotation direction thereof. A blanket cylinder 122b for the other surface is in contact with the impression cylinder 121b. A plate cylinder 123b for the other surface is in contact with the blanket cylinder 122b. An inking device 124b for the other surface, which is ink supply means for the other surface, and a dampening device 125b for the other surface, which is dampening means for the other surface, are provided to the plate cylinder 123b. The impression cylinder 121b, the blanket cylinder 122b, the plate cylinder 123b, the inking device 124b, the dampening device 125b, as described above, and the like constitute an offset printing section for the other surface of the first offset printing unit 120.

As shown in FIG. 2, in the same manner as the inking device 124a, the inking device 124b includes: two ink fountains 124ba1 and 124ba2 which are capable of containing inks of colors different from each other; fountain rollers 124bb1 and 124bb2 which take out the ink from the respective ink fountains 124ba1 and 124ba2; ink ductor rollers 124bc1 and 124bc2 which each have a large-diameter portion and a small-diameter portion at predetermined positions in an axial direction thereof and which receive the ink taken out by the respective fountain rollers 124bb1 and 124bb2 on only the large-diameter portions; a roller train 124be to which the ink is transferred from the large-diameter portions of the ink ductor rollers 124bc1 and 124bc2 and which then sends the ink to the plate cylinder 123b; and oscillating rollers 124bd1 to 124bd4 which are disposed between the rollers of the roller train 124be and which are capable of reciprocally moving in the axial direction.

As shown in FIG. 1, an impression cylinder 131a for one surface of a second offset printing unit 130 is in contact with the impression cylinder 121b for the other surface of the first offset printing unit 120 at a position downstream of the position where the blanket cylinder 122b is in contact with the impression cylinder 121b in a rotation direction thereof. In the same manner as the first offset printing unit 120, the second printing unit 130 includes a blanket cylinder 132a, a plate cylinder 133a, an inking device 134a, a dampening device 135a, and the like for one surface, which constitute an offset printing section for one surface thereof, and includes a blanket cylinder 132b, a plate cylinder 133b, an inking device 134b, a dampening device 135b, and the like for the other surface, which constitute an offset printing section for the other surface thereof.

An impression cylinder 141a for one surface of a third offset printing unit 140 is in contact with the impression cylinder 131b for the other surface of the second offset printing unit 130 at a position downstream of the position where the blanket cylinder 132b is in contact with the impression cylinder 131b in a rotation direction thereof. In the same manner as the first and second printing units 120 and 130, the third offset printing unit 140 includes a blanket cylinder 142a, a plate cylinder 143a, an inking device 144a, and a dampening device 145a, and the like for one surface, which constitute an offset printing section for one surface thereof, and includes a blanket cylinder 142b, a plate cylinder 143b, an inking device 144b, and a dampening device 145b for the other surface, which constitute an offset printing section for the other surface thereof.

An impression cylinder 151a for one surface of a fourth offset printing unit 150 is in contact with the impression cylinder 141b for the other surface of the third offset printing unit 140 at a position downstream of the position where the blanket cylinder 142b is in contact with the impression cylinder 141b in a rotation direction thereof. In the same manner as the first to third offset printing units 120, 130, and 140, the fourth offset printing unit 150 includes a blanket cylinder 152a, a plate cylinder 153a, an inking device 154a, and a dampening device 155a for one surface, which constitute an offset printing section for one surface thereof, and includes a blanket cylinder 152b, a plate cylinder 153b, an inking device 154b, and a dampening device 145b for the other surface, which constitute an offset printing section for the other surface thereof.

A transport cylinder 171Aa for one surface of a first drying unit 170A is in contact with the impression cylinder 151b for the other surface of the fourth offset printing unit 150 at a position downstream of the position where the blanket cylinder 152b is in contact with the impression cylinder 151b in a rotation direction thereof. A dryer 172Aa for one surface, which is drying means for one surface for drying the one surface of the sheet 101 subjected to printing in the first to fourth offset printing units 120, 130, 140, and 150, is disposed near the transport cylinder 171Aa. A transport cylinder 171Ab for the other surface is in contact with the transport cylinder 171Aa at a position downstream of the position where the impression cylinder 151b for the other surface of the fourth offset printing unit 150 is in contact with the transport cylinder 171Aa in a rotation direction thereof. A dryer 172Ab for the other surface, which is drying means for the other surface for drying the other surface of the sheet 101 subjected to printing in the first to fourth offset printing units 120, 130, 140, and 150, is disposed near the transport cylinder 171Ab.

A screen printing unit 160 described in the aforementioned Patent Literature 3 is disposed such that an impression cylinder 161 thereof is in contact with the transport cylinder 171Ab for the other surface of the first drying unit 170A at a position downstream of the position where the transport cylinder 171Aa for one surface is in contact with the transport cylinder 171Ab in a rotation direction thereof. A rotary screen 162 is in contact with the impression cylinder 161. A transport cylinder 163 is in contact with the impression cylinder 161 at a position downstream of the position where the rotary screen 162 is in contact with the impression cylinder 161 in a rotation direction thereof.

A transport cylinder 171B of a second drying unit 170B is in contact with the transport cylinder 163 of the screen printing unit 160 at a position downstream of the position where the impression cylinder 161 is in contact with the transport cylinder 163 in a rotation direction thereof. A dryer 172B, which is drying means for drying the one surface of the sheet 101 subjected to screen printing in the screen printing unit 160, is disposed near the transport cylinder 171B.

A transport cylinder 173B is in contact with the transport cylinder 171B at a position downstream of the position where the transport cylinder 163 of the screen printing unit 160 is in contact with the transport cylinder 172B in a rotation direction thereof. A transport cylinder 174B is in contact with the transport cylinder 173B at a position downstream of the position where the transport cylinder 171B is in contact with the transport cylinder 173B in a rotation direction thereof. A transfer cylinder 170Ba is in contact with the transport cylinder 174B at a position downstream of the position where the transport cylinder 173B is in contact with the transport cylinder 174B in a rotation direction thereof.

An intaglio printing unit 180, which is similar to the intaglio printing press described in the aforementioned Patent Literature 4, is disposed such that a transfer cylinder 180a thereof is in contact with the transfer cylinder 170Ba of the drying unit 170B at a position downstream of the position where the transport cylinder 174B is in contact with the transfer cylinder 170Ba in a rotation direction thereof. An impression cylinder 181 is in contact with the transfer cylinder 180a at a position downstream of the position where the transfer cylinder 170Ba is in contact with the transfer cylinder 180a in a rotation direction thereof.

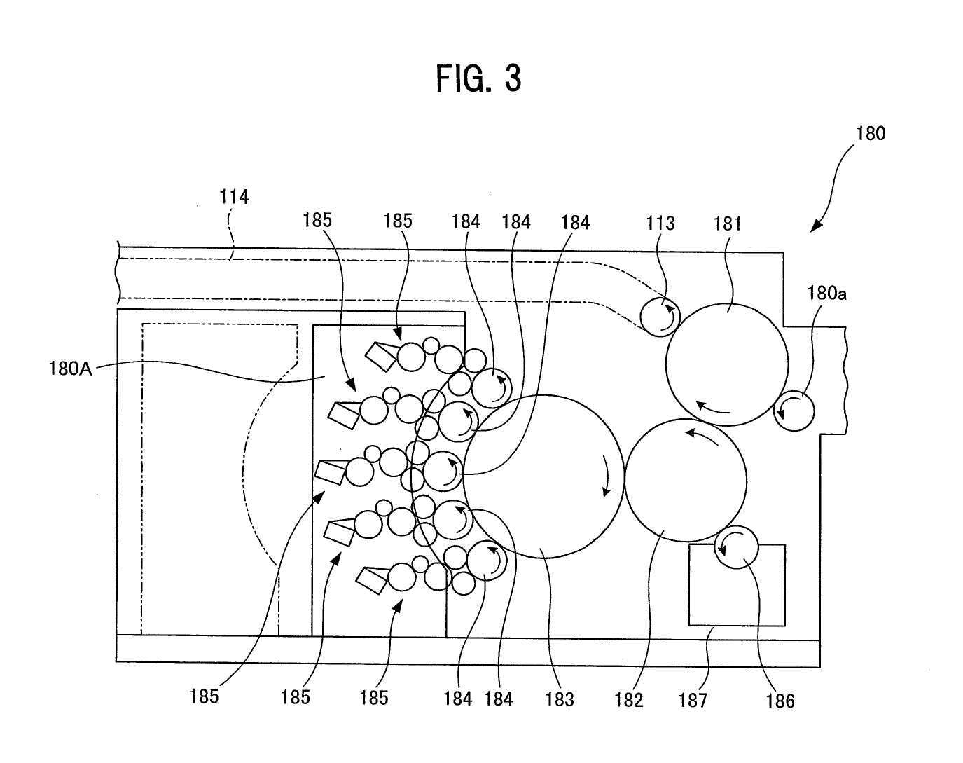

As shown in FIGS. 1 and 3, an intaglio cylinder 182 is in contact with the impression cylinder 181. An ink collecting cylinder 183 is in contact with the intaglio cylinder 182. A plurality of ink form cylinders 184 (five in the embodiment) are in contact with the ink collecting cylinder 183 in such a manner as to be arranged along a circumferential direction thereof. Inking devices 185 for supplying inks are disposed on the peripheral side of these ink form cylinders 184, correspondingly. The inking devices 185 are supported in a frame 180A, which is capable of approaching and separating from the ink form cylinders 184. A wiping roller 186 is in contact with the intaglio cylinder 182. A wiping tank 187 is disposed below the wiping roller 186. Note that in the embodiment, the ink collecting cylinder 183, the ink form cylinders 184, the inking devices 185, and the like constitute ink supply means.

As shown in FIG. 1, a delivery cylinder 113 of a delivery device 112 is in contact with the impression cylinder 181 at a position downstream of the position where the intaglio cylinder 182 is in contact with the impression cylinder 181 in a rotation direction thereof. An unillustrated sprocket is provided coaxially to the delivery cylinder 113. An endless delivery chain 114 provided with a plurality of gripper bars is looped around the sprocket. A plurality of delivery piles 115A to 115C (three in the embodiment), each of which is a piling unit, are arranged in a running direction of the delivery chain 114 below the delivery chain 114.

Then, each of the first to fourth offset printing units 120, 130, 140, and 150 constitutes one module including the offset printing section for one surface and the offset printing section for the other surface in the unit, and a plurality of the units are capable of being coupled and installed. Accordingly, the maximum number of colors required for printing can be easily set by changing the number of units.

Note that in the embodiment, the impression cylinder 161 and the transport cylinder 163 of the screen printing unit 160, the transport cylinder 171Aa for one surface and the transport cylinder 171Ab for the other surface of the first drying unit 170A, the transfer cylinder 170Ba, the transport cylinder 171B, and the transport cylinders 173B and 174B of the second drying unit 170B, and the transfer cylinder 180a of the intaglio printing unit 180 each constitute a sheet forwarding cylinder which forwards the sheet 101 subjected to offset printing in the offset printing units 120, 130, 140, and 150 to the impression cylinder 181 of the intaglio printing unit 180.

### <<Plate Clamping Device of Plate Cylinder>>

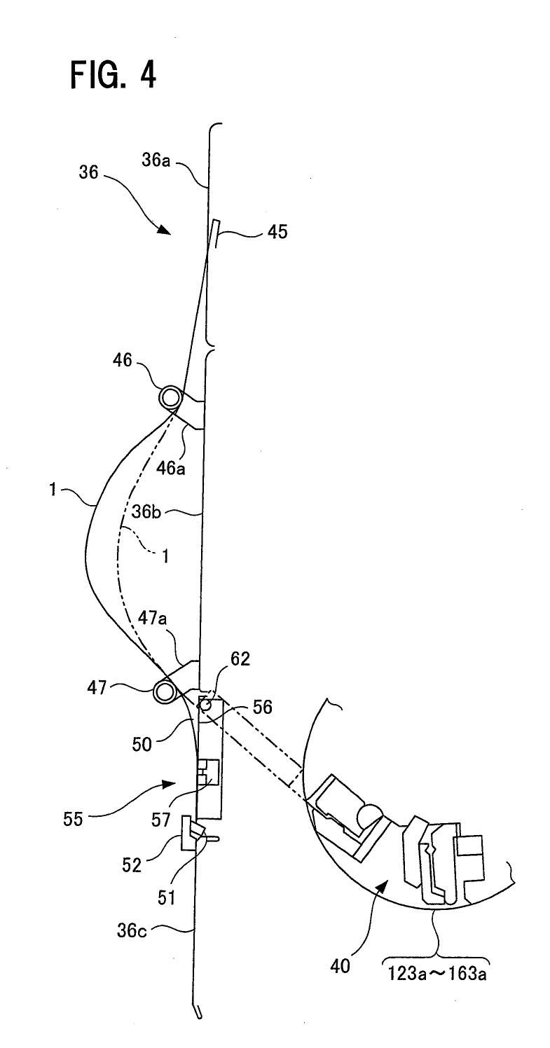

In addition, as shown in FIGS. 3 and 4, the plate cylinders 123a, 133a, 143a, and 153a for one surface and the plate cylinders 123b, 133b, 143b, and 153b for the other surface of the offset printing units 120, 130, 140, and 150 each include a plate clamping device 40 described in the aforementioned Patent Literature 5. Each plate cylinder is thus capable of detachably holding a printing plate, such as a resin plate or a PS plate, on a peripheral surface of the plate cylinder by means of the plate clamping device 40.

### <<Printing Plate Mounting Device>>

Moreover, the offset printing units 120, 130, 140, and 150 each include printing plate mounting devices, described in the aforementioned Patent Literatures 6 and 7 and the like, near the plate cylinders 123a and 123b, 133a and 133b, 143a and 143b, or 153a and 153b. Thus, it is possible to semi-automatically mount the printing plate on each plate cylinders 123a, 133a, 143a, or 153a for one surface via the plate clamping device 40 by means of the printing plate mounting device (plate changing means for one surface) provided near the plate cylinder 123a, 133a, 143a, or 153a while it is possible to semi-automatically mount the printing plate on each plate cylinder 123b, 133b, 143b, or 153b for the other surface via the plate clamping device 40 by means of the printing plate mounting device (plate changing means for the other surface) provided near the plate cylinder 123b, 133b, 143b, or 153b.

Specifically, as shown in FIG. 4, a locking portion 45 is provided in an upper cover 36a of a safety cover 36 covering a front surface of the offset printing section for one surface of each of the offset printing units 120, 130, 140, and 150. The locking portion 45 is formed in an inverted L-shape in a side view and is configured to lock an end portion of a printing plate 1 on the trailing edge side. Reference signs 46 and 47 denote a pair of guide bars each formed in a bar shape. These guide bars 46 and 47 are supported, each at two ends thereof, respectively on upper and lower sides of a middle cover 36b of the safety cover 36 by supporting members 46a and 47a, in parallel with an outer surface of the middle cover 36b at an interval therebetween, and such that the axes of the guide bars 46 and 47 extend in a width direction of the middle cover 36b.

A window 50 formed in a rectangle extending in a left-right direction is provided in an upper portion of a lower cover 36c of the safety cover 36. A pair of left and right positioning pins 51 are fixed to the lower cover 36c via a supporting plate 52 at positions corresponding to lower end portions of the window 50. As shown in the same drawing, the printing plate 1 is engaged with the positioning pins 51 to thus support a lower end of the printing plate 1 with the positioning pins 51 so that the printing plate 1 can be supported by the safety cover 36 before being mounted on the plate cylinder 123a, 133a, 143a, or 153a.

A plate feeding unit 55 as a swing member generally includes: a swing plate 56 which selectively covers the window 50; and a suction pad 57 which sucks the printing plate 1. A large number of holes, through which the suction pad 57 is exposed, are provided in a lower portion of the swing plate 56. The swing plate 56 is supported on the middle cover 36b in such a manner as to be swingable about a pivot shaft 62 implanted on the lower cover 36c as the turning center. The suction pad 57 is supported in such a manner as to be movable on the back surface side of the swing plate 56 along a radial direction of the pivot shaft 62, and is supplied with a suction air from an air intake pump whose illustration is omitted.

The printing plate 1 is mounted in the following manner by the printing plate mounting device configured as described above. First, the end portion to be gripped (lower end portion in the drawing) of the printing plate 1 is engaged with the positioning pins 51, so that the lower end of the printing plate 1 is supported with the positioning pins 51. Next, the upper portion and the lower portion of the printing plate 1 are placed into contact with the pair of guide bars 46 and 47. Thereafter, the upper end of the printing plate 1 is engaged with the locking portion 45, so that the printing plate 1 is supported by the safety cover 36. The printing plate 1 thus supported is bent largely in the side view between the pair of guide bars 46 and 47. In this state, the lower end portion of the printing plate 1 is sucked by the suction pad 57 of the plate feeding unit 55.

Then, the plate feeding unit 55 is turned about the pivot shaft 62 serving as the turning center in the counterclockwise direction in the drawing to bring the lower end of the plate feeding unit 55 near the plate cylinder 123a, 133a, 143a, or 153a, so that the plate feeding unit 55 is positioned at an insertion position. In this event, the movement of the plate feeding unit 55 to the insertion position is utilized to release the engagement of the printing plate 1 and the positioning pins 51. This configuration eliminates the need of dedicated drive means for moving the positioning pins 51, thus simplifying the device and reducing the manufacturing costs.

Subsequently, the suction pad 57 is moved to be brought near the plate cylinder 123a, 133a, 143a, or 153a to insert the lower end (end portion to be gripped) of the printing plate 1 into the inside, on the gripping side, of the plate clamping device 40 of the plate cylinder 123a, 133a, 143a, or 153a. Thereafter, the suction of the printing plate 1 by the suction pad 57 is released, and thereby the lower end (end portion to be gripped) of the printing plate 1, which has been held in the bending state by the suction pad 57, is pressed against the inside, on the gripping side, of the plate clamping device 40 of the plate cylinder 123a, 133a, 143a, or 153a by an elastic returning force generated by the bending, so that the printing plate 1 is positioned.

On the other hand, as shown in FIG. 4, the offset printing section for the other surface of each printing unit 120, 130, 140, or 150 is provided with a printing plate mounting device, which has a structure obtained by turning upside down the structure of the printing plate mounting device provided in the offset printing section for one surface. The printing plate mounting device of the offset printing section for the other surface is capable of operating in the same manner as that of the above-described printing plate mounting device of the offset printing section for one surface, thereby mounting the printing plate 1 on the plate cylinder 123a, 133a, 143a, 153a, or 163a.

### <<Oscillation Adjusting Device for Oscillating Roller>>

Moreover, the oscillating rollers 124ad1 to 124ad4, 134ad1 to 134ad4, 144ad1 to 144ad4, and 154ad1 to 154ad4 of the inking devices 124a, 134a, 144a, and 154a for one surface as well as the oscillating rollers 124bd1 to 124bd4, 134bd1 to 134bd4, 144bd1 to 144bd4, and 154bd1 to 154bd4 of the inking devices 124b, 134b, 144b, and 154b for the other surface, of the printing units 120, 130, 140, and 150 are configured such that the oscillations of the oscillating rollers are adjustable for each of the inking devices 124a, 124b, 134a, 134b, 144a, 144b, 154a, and 154b of the printing units 120, 130, 140, and 150 by an oscillation adjusting device described in the aforementioned Patent Literature 8.

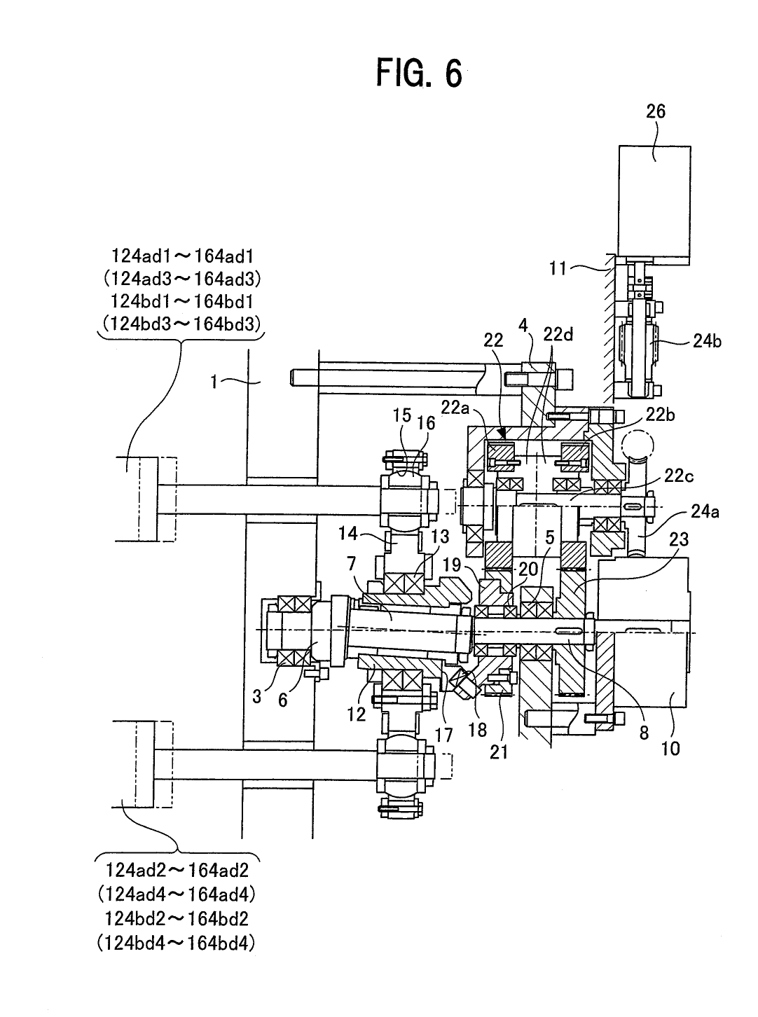

Specifically, as shown in FIG. 6, each of the oscillating rollers 124ad1 to 154ad1, 124ad2 to 154ad2, 124ad3 to 154ad3, 124ad4 to 154ad4, 124bd1 to 154bd1, 124bd2 to 154bd2, 124bd3 to 154bd3, and 124bd4 to 154bd4 is rotatably supported on the frame 1 with a shaft. A rotary shaft 6, which is rotatably supported by a bearing 3 provided in the frame 1 and a bearing 5 of a first support plate 4 screwed to the frame 1, is provided in a center portion substantially the same distance from the oscillating rollers 124ad1 to 154ad1, 124ad2 to 154ad2, 124ad3 to 154ad3, 124ad4 to 154ad4, 124bd1 to 154bd1, 124bd2 to 154bd2, 124bd3 to 154bd3, and 124bd4 to 154bd4.

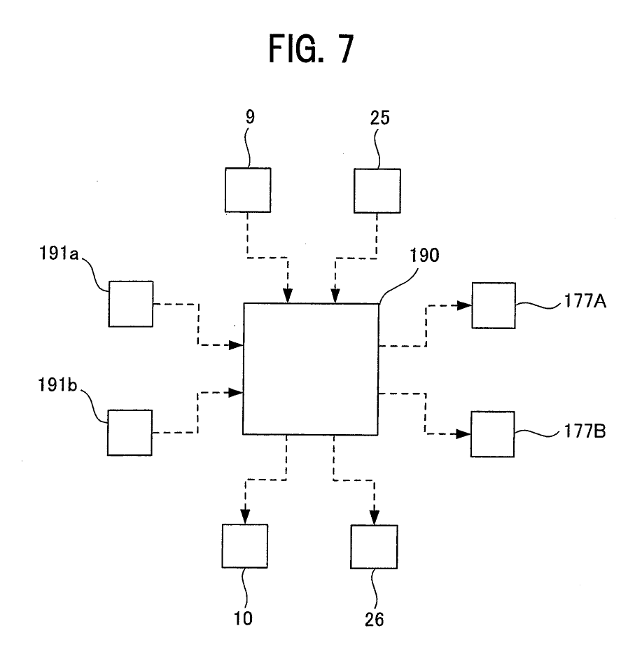

The rotary shaft 6 includes an inclined shaft portion 7 and a parallel shaft portion 8 arranged adjacent to each other. The inclined shaft portion 7 is configured to be inclined to the axis of the oscillating roller 124ad1 to 154ad1, 124ad2 to 154ad2, 124ad3 to 154ad3, 124ad4 to 154ad4, 124bd1 to 154bd1, 124bd2 to 154bd2, 124bd3 to 154bd3, or 124bd4 to 154bd4 while the parallel shaft portion 8 has an axis parallel to the axis of the oscillating roller 124ad1 to 154ad1, 124ad2 to 154ad2, 124ad3 to 154ad3, 124ad4 to 154ad4, 124bd1 to 154bd1, 124bd2 to 154bd2, 124bd3 to 154bd3, or 124bd4 to 154bd4. At the parallel shaft portion 8, the rotary shaft 6 is supported on the first support plate 4 and is directly connected to an oscillation drive motor (first drive means, a dedicated motor) 10 incorporating a rotary encoder 9 (see FIG. 7), which is formed by a disk servo-motor or the like. The oscillation drive motor 10 is laterally attached to a second support plate 11 screwed to the first support plate 4.

A cylindrical sleeve 12, which has an outer peripheral surface inclined to the axis of the inclined shaft portion 7 of the rotary shaft 6, is fitted on the inclined shaft portion 7 in such a manner as to be rotatable but not movable in the axial direction. A disk (oscillating roller engagement member) 14 is supported on the outer peripheral surface of the sleeve 12 via a bearing 13 in such a manner as to be rotatable but not movable in the axial direction. A spherical body 16 provided on a shaft end of each oscillating rollers 124ad1 to 154ad1, 124ad2 to 154ad2, 124ad3 to 154ad3, 124ad4 to 154ad4, 124bd1 to 154bd1, 124bd2 to 154bd2, 124bd3 to 154bd3, or 124bd4 to 154bd4 is fitted to a spherical bearing (engaging portion) 15 provided on an outer peripheral portion of the disk 14.

A fitting groove (engaging portion) 17 is formed in a part of an outer periphery of the sleeve 12. A rotating member 19 having a fitting protrusion (engaged portion, such as a square pin, a round pin, a cam follower, or the like) 18 to be fitted into the fitting groove 17 is rotatably supported on the parallel shaft portion 8 of the rotary shaft 6 via a bearing 20.

An annular gear 21 is fitted on an outer periphery of the rotating member 19. An output gear 22a of a harmonic drive (registered trademark) device 22, serving as a differential mechanism, mounted on the first support plate 4 is in mesh with the annular gear 21. On the other hand, an input gear 22b of the harmonic drive (registered trademark) device 22 is in mesh with a disk-shaped gear 23 fixedly provided on the parallel shaft portion 8 of the rotary shaft 6. In addition, the rotation of an oscillation adjusting motor (second drive means, a dedicated motor) 26 incorporating a potentiometer 25 (see FIG. 7), which is vertically attached to the second support plate 11, is transmitted to a wave generator 22c of the harmonic drive (registered trademark) device 22 via a worm wheel 24a and a worm 24b.

The harmonic drive (registered trademark) device 22 is a known differential mechanism including, as basic elements: the wave generator 22c; a flex spline (not shown) fitted on an outer periphery of the wave generator 22c; and a pair of circular splines 22d in mesh with an outer periphery of the flex spline, in which the number of teeth of the circular splines 22d is two more than the number of teeth of the flex spline, and the output gear 22a is screwed into one of the circular splines 22d while the input gear 22b is screwed into the other circular spline 22d, and the reduction ratio is determined by the numbers of teeth of the flex spline and the circular splines 22d.

Accordingly, during normal operation, stopping the oscillation adjusting motor 26 transmits the rotation of the oscillation drive motor 10 to the disk-shaped gear 23 the harmonic drive (registered trademark) device 22 the annular gear 21 and the rotating member 19 in a ratio of 1:1, so that the sleeve 12, which rotates integrally with the rotating member 19, rotates at the same number of revolutions as that of the rotary shaft 6. On the other hand, rotating the oscillation adjusting motor 26 generates a slight difference in rotation between the disk-shaped gear 23, which is rotated by the oscillation drive motor 10, and the annular gear 21 and rotating member 19 due to the reduction action of the harmonic drive (registered trademark) device 22. The slight difference in rotation causes phase adjustment between the rotary shaft 6 (inclined shaft portion 7) and the sleeve 12, so that the oscillation of each oscillating roller 124ad1 to 154ad1, 124ad2 to 154ad2, 124ad3 to 154ad3, 124ad4 to 154ad4, 124bd1 to 154bd1, 124bd2 to 154bd2, 124bd3 to 154bd3, or 124bd4 to 154bd4 is adjusted. After the adjustment, stopping the oscillation adjusting motor 26 causes the number of revolutions of the sleeve 12 to return to the initial number of revolutions (the same number of revolutions as that of the rotary shaft 6).

Further, as shown in FIG. 7, the rotary encoder 9 and the potentiometer 25 are electrically connected to an input unit of a control device 190, which is control means. An output unit of the control device 190 is electrically connected to the motors 10 and 26. The control device 190 is thus capable of controlling the operations of the motors 10 and 26 on the basis of signals from the rotary encoder 9 and the potentiometer 25.

During normal operation, the oscillation adjusting device configured as described above rotates the oscillation drive motor 10 in a state where the oscillation adjusting motor 26 is stopped. This causes the sleeve 12 to rotate at the same number of revolutions as that of the rotary shaft 6 (inclined shaft portion 7) and the disk 14 to precess in conjunction with the precession of the inclined shaft portion 7, as described above. As a result, the oscillating rollers 124ad1 to 154ad1, 124ad2 to 154ad2, 124ad3 to 154ad3, 124ad4 to 154ad4, 124bd1 to 154bd1, 124bd2 to 154bd2, 124bd3 to 154bd3, and 124bd4 to 154bd4 are caused to oscillate in the axial direction sequentially at different phases and in a predetermined oscillation.

In this event, after initial position synchronization is performed between the initial position of the oscillation drive motor 10 and the initial position of the prime motor, the initial position of the oscillation drive motor 10 is shifted by a predetermined amount from the initial position of the prime motor, thereby adjusting the oscillation phase of each of the oscillating rollers 124ad1 to 154ad1, 124ad2 to 154ad2, 124ad3 to 154ad3, 124ad4 to 154ad4, 124bd1 to 154bd1, 124bd2 to 154bd2, 124bd3 to 154bd3, and 124bd4 to 154bd4 to a predetermined oscillation phase.

Then, under the above-described conditions, rotating the oscillation adjusting motor 26 causes a slight difference in rotation between the disk-shaped gear 23, which is rotated by the oscillation drive motor 10, and the annular gear 21 and rotating member 19 due to the action of the harmonic drive (registered trademark) device 22. The slight difference in rotation causes phase adjustment between the rotary shaft 6 (inclined shaft portion 7) and the sleeve 12, so that the oscillation of each oscillating roller 124ad1 to 154ad1, 124ad2 to 154ad2, 124ad3 to 154ad3, 124ad4 to 154ad4, 124bd1 to 154bd1, 124bd2 to 154bd2, 124bd3 to 154bd3, or 124bd4 to 154bd4 is changed by the amount of rotation of the oscillation adjusting motor 26. As a result, the oscillation of the oscillating roller 124ad1 to 154ad1, 124ad2 to 154ad2, 124ad3 to 154ad3, 124ad4 to 154ad4, 124bd1 to 154bd1, 124bd2 to 154bd2, 124bd3 to 154bd3, or 124bd4 to 154bd4 is adjusted to the predetermined oscillation.

### <<Sheet Sorting Device>>

In addition, as shown in FIG. 1, release cams 116A to 116C, which are release means for releasing gripper devices of the gripper bars of the delivery chain 114, are disposed near the delivery chain 114 on the respective delivery piles 115A to 115C of the delivery device 112. Elevating devices (see FIG. 6) 117A and 117B, such as air cylinders, which are approach and separation means, are coupled respectively to the two release cams 116A and 116B located closer to the delivery cylinder 113 among the release cams 116A to 116C. The elevating devices 117A and 117B are configured to move up and down to cause the corresponding release cams 116A and 116B to approach or separate from the delivery chain 114.

Moreover, a checking camera 191a for one surface, which is checking means for one surface for detecting a printing condition of one surface of the sheet 101, is disposed near the transport cylinder 174B of the second drying unit 170B, in other words, between a downstream side, in the transporting direction of the sheet 101, of a position (printing portion) where the impression cylinder 151a and the blanket cylinder 152a are in contact with each other in the offset printing section for one surface of the fourth offset printing unit 150, which is located on the most downstream side in the transporting direction of the sheet 101, and an upstream side, in the transporting direction of the sheet 101, of the impression cylinder 181 of the intaglio printing unit 180. In addition, a checking camera 191b for the other surface, which is checking means for the other surface for detecting a printing condition of the other surface of the sheet 101, is disposed near the transport cylinder 173B, in other words, between a downstream side, in the transporting direction of the sheet 101, of a position (printing portion) where the impression cylinder 151b and the blanket cylinder 152b are in contact with each other in the offset printing section for the other surface of the fourth offset printing unit 150, which is located on the most downstream side in the transporting direction of the sheet 101, and an upstream side, in the transporting direction of the sheet 101, of the impression cylinder 181 of the intaglio printing unit 180.

As shown in FIG. 7, the checking cameras 191a and 191b are electrically connected to the input unit of the control device 190. The output unit of the control device 190 is electrically connected to the elevating devices 117A and 117B. The control device 190 is thus capable of causing the elevating devices 117A and 117B to move up and down on the basis of signals from the checking cameras 191a and 191b.

### <<Printing Operation>>

Next, an operation of the security printing press 100 according to the embodiment will be described.

When the sheet 101 is fed one by one from the sheet feeding device 110, the sheet 101 is transferred from the feeder board 111, the feedboard 112, and the swing arm shaft pregripper 113, through the transfer cylinder 120a of the first offset printing unit 120, to the impression cylinder 121a. As a result, the sheet 101 is held on the impression cylinder 121a with the one surface being on the front side.

The inks filled in the respective ink fountains 124aa1 and 124aa2 of the inking device 124a are taken out by the respective fountain rollers 124ab1 and 124ab2, and are transported to the roller train 124ae by the respective ink ductor rollers 124ac1 and 124ac2. Then, part of the inks is mixed into a rainbow state by the above-described reciprocating motions of the oscillating rollers 124ad1 to 124ad4 in the axial direction, and transported to the plate cylinder 123a. The ink is thus transferred onto the blanket cylinder 122a with a printing image corresponding to the pattern of the plate cylinder 123a.

Then, the sheet 101 passes between the impression cylinder 121a and the blanket cylinder 122a, and thereby the ink, which has been transferred in the rainbow state on the surface of the blanket cylinder 122a, is transferred onto one surface of the sheet 101 held on the peripheral surface of the impression cylinder 121a.

The sheet 101 with the one surface subjected to rainbow printing on the impression cylinder 121a is transported to and gripped on the impression cylinder 121b, so that the sheet is held on the impression cylinder 121b with the other surface being on the front side.

Moreover, the inks filled in the respective ink fountains 124ba1 and 124ba2 of the inking device 124b are taken out by the respective fountain rollers 124bb1 and 124bb2, and are transported to the roller train 124be by the respective ink ductor rollers 124bc1 and 124bc2. Then, part of the inks is mixed into a rainbow state by the above-described reciprocating motions of the oscillating rollers 124bd1 to 124bd4 in the axial direction, and transported to the plate cylinder 123b. The ink is thus transferred onto the blanket cylinder 122b with a printing image corresponding to the pattern of the plate cylinder 123b.

Then, the sheet 101 passes between the impression cylinder 121b and the blanket cylinder 122b, and thus the ink, which has been transferred in the rainbow state on the surface of the blanket cylinder 122b, is transferred onto the other surface of the sheet 101 held on the peripheral surface of the impression cylinder 121b.

The sheet 101 with the other surface subjected to rainbow printing on the impression cylinder 121b is transported to and gripped on the impression cylinder 131a of the second offset printing unit 130, so that the sheet is held on the impression cylinder 131a with the one surface being on the front side.

Successively, the sheet 101 is subjected to rainbow printing on the one surface and subjected to rainbow printing on the other surface in the second offset printing unit 130 in the same manner as the first offset printing unit 120, and then is transferred to the third printing unit 140.

Thereafter, the sheet 101 is subjected to the rainbow printing in the third and fourth offset printing units 140 and 150 in the same manner as the first offset printing unit 120. Thereafter, the sheet 101 is gripped on the transport cylinder 171Aa for one surface of the first drying unit 170A, and the ink on the one surface is dried by the dryer 172Aa for one surface while the sheet 101 is held and transported by the transport cylinder 171Aa with the one surface being on the front side. Then, the sheet 101 is gripped on the transport cylinder 171Ab for the other surface, and the ink on the other surface is dried by the dryer 172Ab for the other surface while the sheet 101 is held and transported by the transport cylinder 171Ab with the other surface being on the front side.

Next, the sheet 101 is gripped on the impression cylinder 161 of the screen printing unit 160. The sheet 101 is then subjected to screen printing on the one surface by the rotary screen 162 while being held and transported by the impression cylinder 161 with the one surface being on the front side. Thereafter, the sheet 101 is gripped on the transport cylinder 171B of the second drying unit 170B via the transport cylinder 163, and the ink screen-printed on the one surface of the sheet 101 is dried by the dryer 172B while the sheet 101 is held and transported by the transport cylinder 171Ba with the one surface being on the front side.

Subsequently, the sheet 101 is gripped on the transport cylinder 173B, and the printing condition of the other surface is detected by the checking camera 191b while the sheet 101 is held and transported by the transport cylinder 173B with the other surface being on the front side. Then, the sheet 101 is gripped on the transport cylinder 174B, and the printing condition of the one surface is detected by the checking camera 191a while the sheet 101 is held and transported by the transport cylinder 174B with the one surface being on the front side. Thereafter, the sheet 101 is gripped on the impression cylinder 181 of the intaglio printing unit 180 via the transfer cylinders 170Ba and 180a, so that the sheet 101 is held on the peripheral surface of the impression cylinder 181 with the other surface being on the front side.

The inks in the respective inking devices 185 are transferred to the ink collecting cylinder 183 via the ink form cylinders 184, and supplied to the intaglio cylinder 182. The excess of the inks is wiped out by the wiping roller 186 and cleaned and removed in the wiping tank 187.

Then, the sheet 101 passes between the impression cylinder 181 and the intaglio cylinder 182, and thereby the inks, which has been supplied to the intaglio plate of the intaglio cylinder 182, are transferred to the other surface of the sheet 101 held on the peripheral surface of the impression cylinder 181, and thereafter, the sheet 101 is held and transported by the gripper bar of the delivery chain 114 via the transport cylinder 170a of the delivery device 112.

The control device 190 judges whether or not the printing conditions of the one surface and the other surface of the sheet 101 are appropriate on the basis of signals from the checking cameras 191a and 191b. When judging that the printing conditions of both the one surface and the other surface of the sheet 101 are appropriate, the control device 190 activates one of the elevating devices 117A and 117B to cause a corresponding one of the release cams 116A and 116B to approach the delivery chain 114, and activates the other one of the elevating devices 117A and 117B to cause the corresponding other one of the release cams 116A and 116B to separate from the delivery chain 114.

In this way, the gripper device of the gripper bar of the delivery chain 114, which is holding and transporting the sheet 101, comes into contact with the one of the release cams 116A and 116B and is thus released, so that the sheet 101 is delivered and piled on a corresponding one of the delivery piles 115A and 115B (the delivery pile located below the one of the release cams 116A and 116B).

Once the number of sheets piled on the one of the delivery piles 115A and 115B as described above reaches a predetermined number, the control device 190 activates the other one of the elevating devices 117A and 117B to cause the corresponding other one of the release cams 116A and 116B to approach the delivery chain 114, and activates the one of the elevating devices 117A and 117B to cause the corresponding one of the release cams 116A and 116B to separate from the delivery chain 114.

In this way, the gripper device of the gripper bar of the delivery chain 114, which is holding and transporting the sheet 101, comes into contact with the other one of the release cams 116A and 116B and is thus released, so that the sheet 101 is delivered and piled on the other one of the delivery piles 115A and 115B (the delivery pile located below the other one of the release cams 116A and 116B). Accordingly, after the delivery pile to pile the sheets 101 is switched, the sheets 101 piled up to the predetermined number on the one of the delivery piles 115A and 115B can be carried out. Therefore, the printing products can be carried out without stopping the printing on the sheets 101.

On the other hand, when judging that the printing condition of any of the one surface and the other surface of the sheet 101 is not appropriate, the control device 190 activates the elevating devices 117A and 117B to cause the release cams 116A and 116B to separate from the delivery chain 114.

In this way, the sheet 101 held by the gripper device of the gripper bar of the delivery chain 114 passes through above the delivery piles 115A and 115B without being delivered onto the delivery piles 115A and 115B. Then, the gripper device comes into contact with the release cam 116C and is released, so that the sheet 101 is delivered on the delivery pile 115C and piled as a wasted sheet.

Therefore, the security printing press 100 according to the embodiment can provide the following advantageous effects.

(1) In each of the offset printing units 120, 130, 140, and 150, one surface of the sheet 101 held on the impression cylinder 121a, 131a, 141a, or 151a with the one surface being on the front side is subjected to offset printing by the blanket cylinder 122a, 132a, 142a, or 152a, and then, the other surface of the sheet 101, which is then gripped and held on the impression cylinder 121b, 131b, 141b, or 151b with the other surface being on the front side, is subjected to offset printing by the blanket cylinder 122b, 132b, 142b, or 152b. In short, the security printing press 100 employs alternate double-sided printing. Therefore, the sheet 101 is pressed against the blanket cylinders 122a, 132a, 142a, 152a, 122b, 132b, 142b, and 152b by the respective impression cylinders 121a, 131a, 141a, 151a, 121b, 131b, 141b, and 151b, making it possible to perform offset printing of sharp printing images on both surfaces of the sheet 101, and continuously perform intaglio printing on the sheet 101 in the intaglio printing unit 180 in line.
(2) The plate cylinders 123a, 123b, 133a, 133b, 143a, 143b, 153a, and 153b of the offset printing units 120, 130, 140, and 150 each include the plate clamping device 40 described in the aforementioned Patent Literature 5 and the like. Therefore, a printing plate, such as a resin plate or a PS plate, can be easily held detachably on the peripheral surface of each plate cylinder.
(3) The offset printing units 120, 130, 140, and 150 each include the printing plate mounting device described in the aforementioned Patent Literatures 6 and 7 and the like. Therefore, a printing plate, such as a resin plate or a PS plate, can be easily mounted on each of the plate cylinders 123a, 123b, 133a, 133b, 143a, 143b, 153a, and 153b, making it possible to significantly reduce the burden on the worker.
(4) In the offset printing units 120, 130, 140, and 150, the inking devices 124a, 134a, 144a, and 154a for one surface and the inking devices 124b, 134b, 144b, and 154b for the other surface each include the two ink fountains 124aa1 to 154aa1, 124aa2 to 154aa2, 124ba1 to 154ba1, 124ba2 to 154ba2, the fountain rollers 124ab1 to 154ab1, 124ab2 to 154ab2, 124bb1 to 154bb1, 124bb2 to 154bb2, the ink ductor rollers 124ac1 to 154ac1, 124ac2 to 154ac2, 124bc1 to 154bc1, 124bc2 to 154bc2, and the oscillating rollers 124ad1 to 154ad1, 124ad2 to 154ad2, 124ad3 to 154ad3, 124ad4 to 154ad4, 124bd1 to 154bd1, 124bd2 to 154bd2, 124bd3 to 154bd3, 124bd4 to 154bd4. In addition, the oscillating rollers 124ad1 to 154ad1, 124ad2 to 154ad2, 124ad3 to 154ad3, 124ad4 to 154ad4, 124bd1 to 154bd1, 124bd2 to 154bd2, 124bd3 to 154bd3, 124bd4 to 154bd4 are each configured such that the oscillation thereof can be adjusted by the oscillation adjusting device described in the aforementioned Patent Literature 8 and the like. Therefore, an ink distribution appropriate for rainbow printing can be easily obtained.
(5) The printing conditions of the one surface and the other surface of the sheet 101 with the one surface and the other surface subjected to printing are detected respectively by the checking cameras 191a and 191b. The control device 19 then controls the operations of the elevating devices 117A and 117B on the basis of signals from the checking cameras 191a and 191b, such that the sheets are sorted to be piled on the delivery piles 115A and 115B for appropriately printed sheets and the delivery pile 115C for wasted sheets. Therefore, the working efficiency can be improved.
(6) Each combination of the impression cylinder 121a, 121b, 131a, 131b, 141a, 141b, 151a, or 151b and the blanket cylinder 122a, 122b, 132a, 132b, 142a, 142b, 152a, or 152b is provided with the plate cylinder 123a, 123b, 133a, 133b, 143a, 143b, 153a, or 153b and the inking device 124a, 124b, 134a, 134b, 144a, 144b, 154a, or 154b. Accordingly, a space is provided between the plate cylinder 123a, 123b, 133a, 133b, 143a, 143b, 153a, or 153b and the inking device 124a, 124b, 134a, 134b, 144a, 144b, 154a, or 154b which are adjacent to each other. This eliminates the need for securing a working space for performing the printing preparation work or the maintenance and inspection work, such as the refilling of the ink, the cleaning of the rubber blanket, and the changing of the printing plate, thus allowing the work to be easily performed. In addition, since the plate cylinders 123a, 123b, 133a, 133b, 143a, 143b, 153a, and 153b, the inking devices 124a, 124b, 134a, 134b, 144a, 144b, 154a, or 154b, and the like are arranged side by side in the horizontal direction, this allows the worker to perform the work at ease. Therefore, the burden on the worker can be significantly reduced.
(7)

Each of the offset printing units 120, 130, 140, and 150 is configured of a module formed by providing each combination of the impression cylinder 121a, 131a, 141a, or 151a and the blanket cylinder 122a, 132a, 142a, or 152a for one surface and the impression cylinder 121b, 131b, 141b, or 151b and the blanket cylinder 122b, 132b, 142b, or 152b for the other surface with the corresponding plate cylinder 123a, 123b, 133a, 133b, 143a, 143b, 153a, or 153b and inking device 124a, 124b, 134a, 134b, 144a, 144b, 154a, or 154b and the like, and a plurality of the printing units are capable of being coupled and installed. Therefore, the maximum number of colors required for printing can be easily set by changing the number of units to be installed.

### Other Embodiments

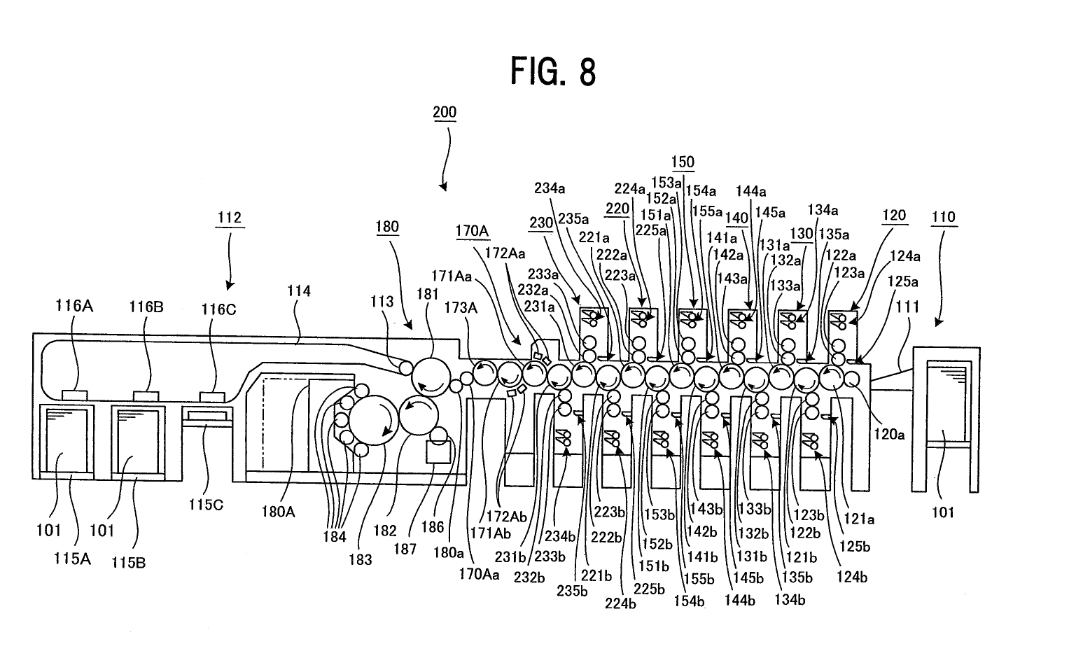

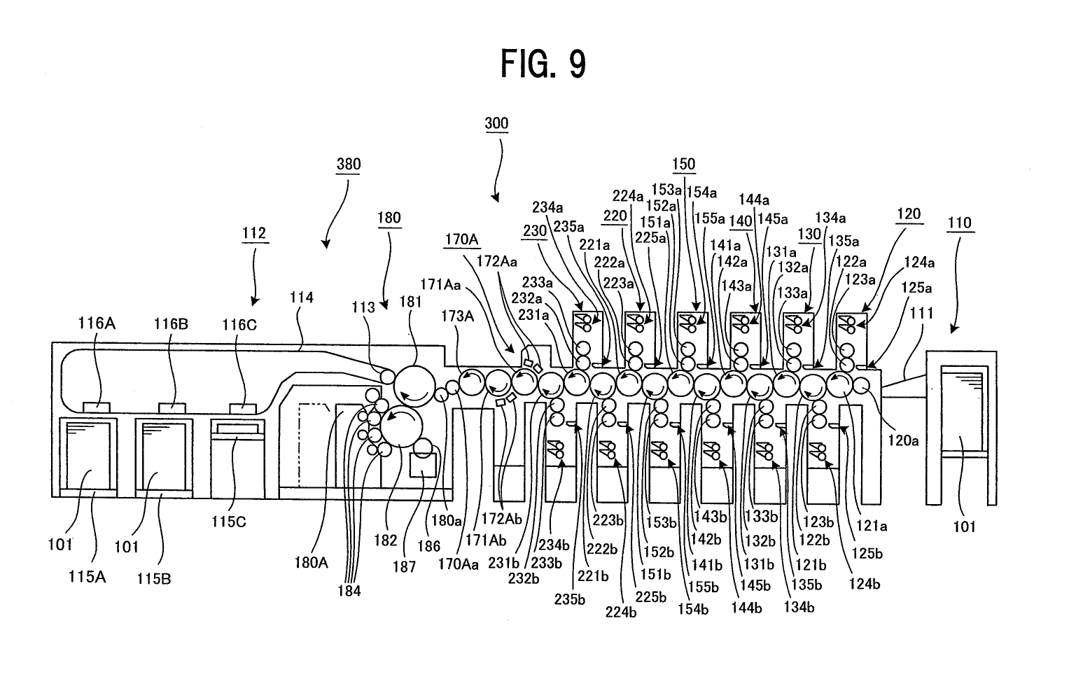

Note that, in the above-described embodiment, description has been given to the security printing press 100 configured by including the four offset printing units (first to fourth offset printing units) 120, 130, 140, and 150, the first drying unit 170A, the screen printing unit 160, the second drying unit 170B, and the intaglio printing unit 180 including the ink collecting cylinder 183, the following is also possible as other embodiments. For example, it is possible to configure, as shown in FIG. 8, a security printing press 200 including: six offset printing units (first to six offset printing units) 120, 130, 140, 150, 220, and 230; a first drying unit 170A; and an intaglio printing unit 180 including an ink collecting cylinder 183 while omitting the screen printing unit 160 and the second drying unit 170B. Further, it is also possible to configure, as shown in FIG. 9, a security printing press 300 including: six offset printing units (first to six offset printing units) 120, 130, 140, 150, 220, and 230; a first drying unit 170A; and an intaglio printing unit 380 in which four ink form cylinders 184 are indirect contact with an intaglio cylinder 182 while omitting the ink collecting cylinder 183 of the intaglio printing unit 180.

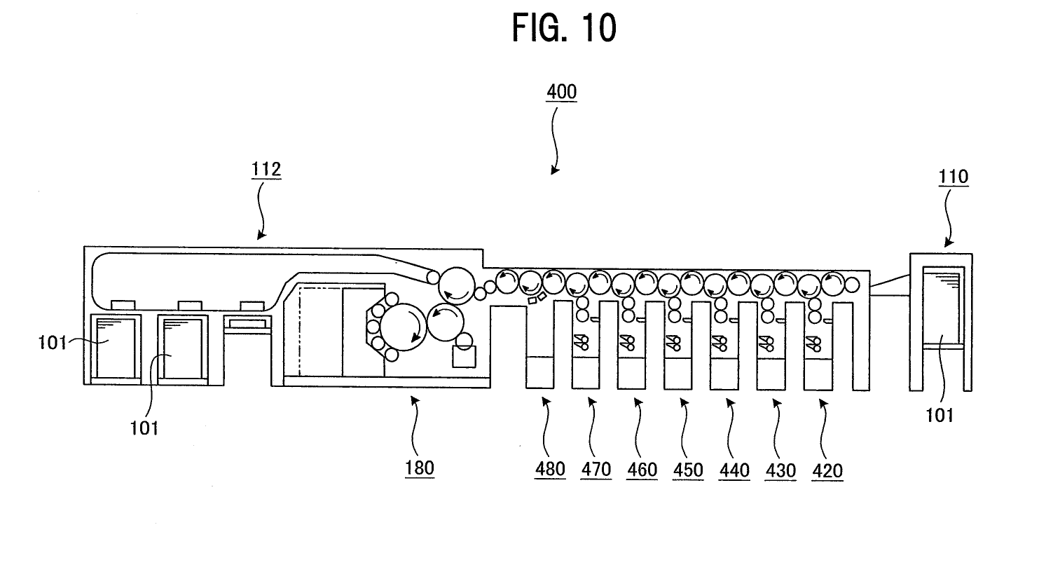

Moreover, in the above-described embodiments, description has been given to the security printing presses 100, 200, and 300 configured by including: the offset printing units 120, 130, 140, 150, 220, and 230 each including the offset printing section for one surface and the offset printing section for the other surface; and the first drying unit 170A, which dries both the one surface and the other surface of the sheet 101. Alternatively, for example, it is possible to configure, as shown in FIG. 10, a security printing press 400 including: offset printing units 420, 430, 440, 450, 460, and 470 each including only the offset printing section for the other surface; and a drying unit 480 which dries only the other surface of the sheet 101, which makes it possible to print securities requiring a printing image on only the other surface of the sheet 101.

### INDUSTRIAL APPLICABILITY

The security printing press according to the present invention is capable of performing offset printing of sharp printing images on a sheet and continuously performing intaglio printing on the sheet in line, and accordingly is very useful to be utilized in the manufacture of banknotes such as bank bills and securities such as stock certificates and bond certificates.

### REFERENCE SIGNS LIST

100 security printing press
101 sheet
110 sheet feeding device
111 feeder board
112 delivery device
113 delivery cylinder
114 delivery chain
115A to 115C delivery pile
116A to 116C release cam
117A, 117B elevating device
120 first offset printing unit
120a transfer cylinder for one surface
121a impression cylinder for one surface
122a blanket cylinder for one surface
123a plate cylinder for one surface
124a inking device for one surface
124aa1, 124aa2 ink fountain
124ab1, 124ab2 fountain roller
124ac1, 124ac2 ink ductor roller
124ad1 to 124ad4 oscillating roller
124ae roller train
125a dampening device for the other surface
120b transfer cylinder for the other surface
121b impression cylinder for the other surface
122b blanket cylinder for the other surface
123b plate cylinder for the other surface
124b inking device for the other surface
124ba1, 124ba2 ink fountain
124bb1, 124bb2 fountain roller
124bc1, 124bc2 ink ductor roller
124bd1 to 124bd4 oscillating roller
124be roller train
125b dampening device for the other surface
130 second offset printing unit
131a impression cylinder for one surface
132a blanket cylinder for one surface
133a plate cylinder for one surface
134a inking device for one surface
134aa1, 134aa2 ink fountain
134ab1, 134ab2 fountain roller
134ac1, 134ac2 ink ductor roller
134ad1 to 134ad4 oscillating roller
134ae roller train
135a dampening device for the other surface
130b transfer cylinder for the other surface
131b impression cylinder for the other surface
132b blanket cylinder for the other surface
133b plate cylinder for the other surface
134b inking device for the other surface
134ba1, 134ba2 ink fountain
134bb1, 134bb2 fountain roller
134bc1, 134bc2 ink ductor roller
134bd1 to 134bd4 oscillating roller
134be roller train
135b dampening device for the other surface
140 third offset printing unit
141a impression cylinder for one surface
142a blanket cylinder for one surface
143a plate cylinder for one surface
144a inking device for one surface
144aa1, 144aa2 ink fountain
144ab1, 144ab2 fountain roller
144ac1, 144ac2 ink ductor roller
144ad1 to 144ad4 oscillating roller
144ae roller train
145a dampening device for the other surface
140b transfer cylinder for the other surface
141b impression cylinder for the other surface
142b blanket cylinder for the other surface
143b plate cylinder for the other surface
144b inking device for the other surface
144ba1, 144ba2 ink fountain
144bb1, 144bb2 fountain roller
144bc1, 144bc2 ink ductor roller
144bd1 to 144bd4 oscillating roller
144be roller train
145b dampening device for the other surface
150 fourth offset printing unit
151a impression cylinder for one surface
152a blanket cylinder for one surface
153a plate cylinder for one surface
154a inking device for one surface
154aa1, 154aa2 ink fountain
154ab1, 154ab2 fountain roller
154ac1, 154ac2 ink ductor roller
154ad1 to 154ad4 oscillating roller
154ae roller train
155a dampening device for the other surface
150b transfer cylinder for the other surface
151b impression cylinder for the other surface
152b blanket cylinder for the other surface
153b plate cylinder for the other surface
154b inking device for the other surface
154ba1, 154ba2 ink fountain
154bb1, 154bb2 fountain roller
154bc1, 154bc2 ink ductor roller
154bd1 to 154bd4 oscillating roller
154be roller train
155b dampening device for the other surface
160 screen printing unit
161 impression cylinder
162 rotary screen
163 transport cylinder
170A first drying unit
171Aa transport cylinder for one surface
172Aa drier for one surface
171Ab transport cylinder for the other surface
172Ab drier for the other surface
170B second drying unit
170Ba transfer cylinder
171B transport cylinder
172B drier
173B, 174B transport cylinder
180 intaglio printing unit
180A frame
180a transfer cylinder
181 impression cylinder
182 intaglio cylinder
183 ink collecting cylinder
184 ink form cylinder
185 inking device
186 wiping roller
187 wiping tank
190 control device
191a checking camera for one surface
191b checking camera for the other surface
200 security printing press
220 fifth offset printing unit
230 sixth offset printing unit
300 security printing press
380 intaglio printing unit
400 security printing press
420 first offset printing unit
430 second offset printing unit
440 third offset printing unit
450 fourth offset printing unit
460 fifth offset printing unit
470 sixth offset printing unit
480 drying unit

1-6. (canceled)

7. A security printing press for printing securities, comprising:
an offset printing unit including an impression cylinder which holds and transports a sheet, a blanket cylinder which is in contact with the impression cylinder, a plate cylinder which is in contact with the blanket cylinder, and ink supply means for supplying ink to the plate cylinder; and
an intaglio printing unit including an impression cylinder which receives the sheet subjected to offset printing in the offset printing unit and holds and transports the sheet, an intaglio cylinder which is in contact with the impression cylinder, an ink collecting cylinder which is in contact with the intaglio cylinder, a plurality of ink form cylinders which are in contact with the ink collecting cylinder, and a plurality of inking devices which are disposed to respectively correspond to the ink form cylinders and which supply ink to the corresponding ink form cylinders.

8. The security printing press according to claim 7, wherein
the offset printing unit includes:
an offset printing section for one surface including an impression cylinder for one surface which holds and transports the sheet, a blanket cylinder for one surface which is in contact with the impression cylinder for one surface and which performs offset printing on one surface of the sheet, a plate cylinder for one surface which is in contact with the blanket cylinder for one surface, and ink supply means for one surface for supplying ink to the plate cylinder for one surface; and
an offset printing section for the other surface including an impression cylinder for the other surface which is in contact with the impression cylinder for one surface of the offset printing section for one surface and which receives the sheet from the impression cylinder for one surface and holds and transports the sheet, a blanket cylinder for the other surface which is in contact with the impression cylinder for the other surface and which performs offset printing on the other surface of the sheet, a plate cylinder for the other surface which is in contact with the blanket cylinder for the other surface, and ink supply means for the other surface for supplying ink to the plate cylinder for the other surface, and
each of the ink supply means for one surface of the offset printing section for one surface and the ink supply means for the other surface of the offset printing section for the other surface includes: two ink fountains; an oscillating roller; and oscillation adjusting means for adjusting oscillation of the oscillating roller.

9. The security printing press according to claim 8, further comprising at least one sheet forwarding cylinder which is disposed between the offset printing unit and the impression cylinder of the intaglio printing unit and which forwards the sheet subjected to offset printing in the offset printing unit to the impression cylinder of the intaglio printing unit.

10. The security printing press according to claim 8, wherein
the offset printing unit is configured as one module formed of the offset printing section for one surface and the offset printing section for the other surface, and
a plurality of the offset printing units are capable of being coupled.

11. The security printing press according to claim 8, further comprising:
checking means for one surface for detecting a printing condition of the one surface of the sheet, the checking means for one surface being disposed between a downstream side, in a transporting direction of the sheet, of a printing portion in the offset printing section for one surface that is located on the most downstream side in the transporting direction of the sheet and an upstream side, in the transporting direction of the sheet, of the impression cylinder of the intaglio printing unit, and
checking means for the other surface for detecting a printing condition of the other surface of the sheet, the checking means for the other surface being disposed between a downstream side, in the transporting direction of the sheet, of a printing portion in the offset printing section for the other surface that is located on the most downstream side in the transporting direction of the sheet and an upstream side, in the transporting direction of the sheet, of the impression cylinder of the intaglio printing unit.

12. The security printing press according to claim 8, further comprising:
plate changing means for one surface for changing a printing plate for the plate cylinder for one surface, the plate changing means for one surface being provided in the offset printing section for one surface; and
plate changing means for the other surface for changing a printing plate for the plate cylinder for the other surface, the plate changing means for the other surface being provided in the offset printing section for the other surface.
